(19) United States
(12) Patent Application Publication
(10) Pub. No.: US 2024/0322680 A1
(43) Pub. Date: Sep. 26, 2024

(54) CHARGE PUMP CIRCUIT

(71) Applicant: LAPIS Technology Co., Ltd., Kanagawa (JP)

(72) Inventor: Shintaro Motoki, Kanagawa (JP)

(21) Appl. No.: 18/609,917

(22) Filed: Mar. 19, 2024

(30) Foreign Application Priority Data
Mar. 20, 2023 (JP) 2023-044773

(51) Int. Cl. H02M 3/07

(52) U.S. Cl. CPC H02M 3/073

(57) ABSTRACT

A charge pump circuit includes a DC power supply VDD, a booster circuit including a booster section and a smoothing section. The booster section includes N capacitors, and the smoothing section includes N−1 capacitors. When a time Tᵢ is indicated by the clock signals, one side of an i^{th} capacitor of the booster section is connected to the DC power supply and an other side of the i^{th} capacitor is connected to a reference potential terminal. When a time Tᵢ₊₁ is indicated, the one side is connected to a first capacitor of the smoothing section and the other side is connected to the DC power supply. When a time Tᵢ₊ⱼ is indicated, the one side is connected to one side of a j^{th} capacitor of the smoothing section and the other side is connected to one side of a j−1^{th} capacitor of the smoothing section.

### CROSS-REFERENCE TO RELATED APPLICATION

This application claims priority under 35 USC 119 from Japanese Patent Application No. 2023-044773, filed on Mar. 20, 2023, the entire disclosure of which is incorporated herein by reference.

### BACKGROUND

### Technical Field

The present disclosure relates to a charge pump circuit.

### Related Art

A booster circuit is disclosed in, for example, Japanese Patent Application Laid-Open (JP-A) No. H02-276467 that includes a charge pump, a power supply input terminal, a first power supply output terminal, a second power supply output terminal, a step-down MOS transistor and potential-altering means. In plural unit circuits of the charge pump, input terminals of diode elements are connected to one ends of capacitors. The plural unit circuits are connected in series, such that the terminals of the plural diode elements are arrayed in the same direction, and the output terminal of a preceding diode element is connected to the input terminal of a succeeding diode element. Mutually anti-phase clock signals are applied to the other terminals of the capacitors of adjacent unit circuits. Thus, charges accumulated on preceding capacitors are transferred to succeeding capacitors by the clock signals and successively boosted. The power supply input terminal inputs a power supply to the charge pump, the first power supply output terminal feeds out a first output voltage from the charge pump, and the second power supply feeds out a second output voltage from the charge pump. The drain and source terminals of the step-down MOS transistor are connected between the first and second power supply output terminals, and the gate terminal is connected to an arbitrary intermediate node of the charge pump. The step-down MOS transistor steps down the first output voltage in accordance with an intermediate potential applied to the gate electrode from the intermediate node, and outputs the stepped-down voltage as the second output voltage. The potential-altering means alters the intermediate potential by altering the feed-out stage of the intermediate node.

### SUMMARY

The present disclosure provides a charge pump circuit that suppresses ripple in an output voltage.

A first aspect of the present disclosure is a charge pump circuit including: a DC power supply; a booster circuit including a booster section and a smoothing section, the booster section including N capacitors, where N is an arbitrary natural number that is at least 3, and the smoothing section including N−1 capacitors; and a clock provision circuit that provides clock signals to the booster circuit, wherein, in a case in which i is natural numbers from 1 to N, and j is natural numbers from 2 to N−1, when a time Ti is indicated by the clock signals, one side of an ith capacitor among the N capacitors of the booster section is connected to a high potential side terminal of the DC power supply, and an other side of the ith capacitor is connected to a reference potential terminal, when a time Ti+1 is indicated by the clock signals, the one side is connected to a terminal at one side of a first capacitor of the smoothing section, and the other side is connected to the high potential side terminal of the DC power supply, and when a time Ti+j is indicated by the clock signals, the one side is connected to a terminal at one side of a jth capacitor of the smoothing section, and the other side is connected to a terminal at one side of a j−1th capacitor of the smoothing section.

In this charge pump circuit, the booster section of the booster circuit includes the N capacitors, where N is the natural number that is at least 3, and the smoothing section includes the N−1 capacitors. In the charge pump circuit, the i^{th} capacitor of the plural capacitors arrayed in sequence in the booster section is connected to the i−1^{th} capacitor of the smoothing section each time the time T advances one step. As a result, in the charge pump circuit according to the present disclosure, the potential that is outputted is raised by the N capacitors of the booster section, each time the time T advances one step, and ripple on a voltage that is outputted may be suppressed.

### BRIEF DESCRIPTION OF THE DRAWINGS

Exemplary embodiments will be described in detail based on the following figures, wherein:

FIG. 1 is a diagram illustrating a charge pump circuit according to a first exemplary embodiment;

FIG. 2 is a timing chart of the charge pump circuit according to the first exemplary embodiment;

FIG. 3 is a diagram illustrating operation of the charge pump circuit according to the first exemplary embodiment, which is a diagram illustrating connection states when a time T₁ is indicated by clock signals;

FIG. 4 is a diagram illustrating operation of the charge pump circuit according to the first exemplary embodiment, which is a diagram illustrating connection states when a time T₂ is indicated by the clock signals;

FIG. 5 is a diagram illustrating operation of the charge pump circuit according to the first exemplary embodiment, which is a diagram illustrating connection states when a time T₃ is indicated by the clock signals;

FIG. 6 is a diagram illustrating a charge pump circuit according to a comparative example;

FIG. 7 is a timing chart of the charge pump circuit according to the comparative example;

FIG. 8 is a diagram illustrating operation of the charge pump circuit according to the comparative example, which is a diagram illustrating connection states when a time T₁ is indicated by clock signals;

FIG. 9 is a diagram illustrating operation of the charge pump circuit according to the comparative example, which is a diagram illustrating connection states when a time T₂ is indicated by the clock signals;

FIG. 10 is a diagram illustrating operation of the charge pump circuit according to the comparative example, which is a diagram illustrating connection states when a time T₃ is indicated by the clock signals;

FIG. 11 is a diagram illustrating a charge pump circuit according to a second exemplary embodiment;

FIG. 12 is a timing chart of the charge pump circuit according to the second exemplary embodiment;

FIG. 13 is a diagram illustrating a charge pump circuit according to a third exemplary embodiment; and

FIG. 14 is a timing chart of the charge pump circuit according to the third exemplary embodiment.

### DETAILED DESCRIPTION

Below, examples of embodiments of the present disclosure are described with reference to the drawings. In the drawings, the same reference symbols are assigned to structural elements and components that are the same or equivalent. Proportional dimensions in the drawings may be exaggerated to aid understanding and may be different from actual proportions.

In the modes described below, the charge pump circuit according to the present disclosure includes a booster circuit that includes a booster section including N capacitors, where N is an arbitrary natural number that is at least 3, and a smoothing section including N−1 capacitors. As examples below, a first exemplary embodiment in which 3 is assigned as the natural number N, a second exemplary embodiment in which 6 is assigned as the natural number N, and a third exemplary embodiment that is a general case in which no value of the natural number N is specified, are described with reference to the drawings.

According to the exemplary embodiments described below, the charge pump circuit according to the present disclosure may suppress ripple in an output voltage.

### First Exemplary Embodiment

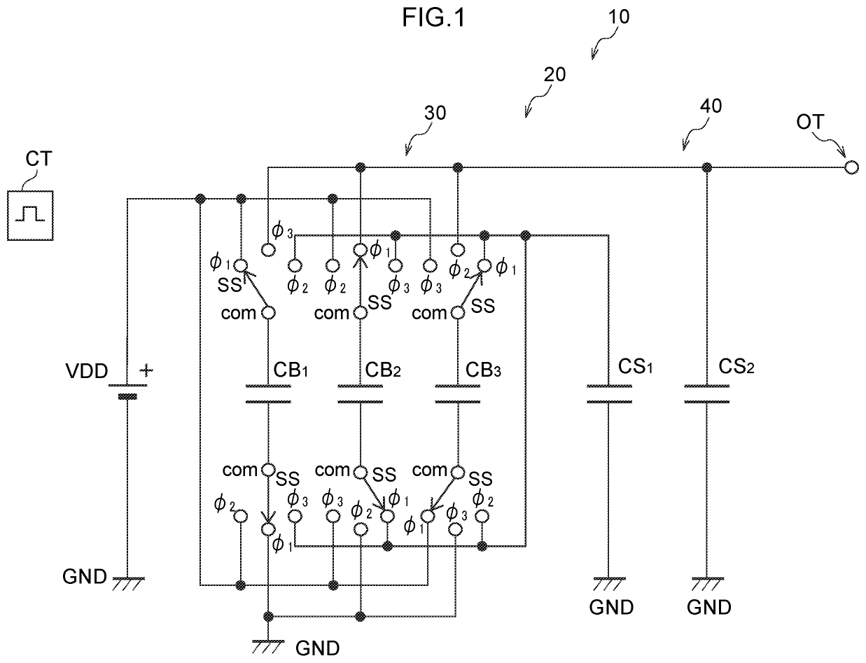

FIG. 1 is a diagram illustrating a charge pump circuit 10 according to the first exemplary embodiment of the present disclosure. As illustrated in FIG. 1, the charge pump circuit 10 according to the present disclosure includes a DC power supply VDD, a clock provision circuit CT and a booster circuit 20.

The DC power supply VDD is a structural component that supplies the DC power supply VDD to the charge pump circuit 10. One side of the DC power supply VDD, which is the high potential side (the upper side in the drawing of FIG. 1), is connected to the booster circuit 20, which is described below, and the other side of the DC power supply VDD (the lower side in the drawing of FIG. 1) is connected to a reference potential GND (ground) terminal.

The clock provision circuit CT is a circuit that provides clock signals to the booster circuit 20 as described below. The clock provision circuit CT may have any configuration but is formed, for example, as a circuit that outputs a rectangular waveform at a pre-specified frequency; times T are represented by numbers of rises and falls of the rectangular waveform.

As illustrated in FIG. 1, the booster circuit 20 includes a booster section 30 including three capacitors and a smoothing section 40 including two capacitors. That is, the capacitors of the smoothing section 40 are one fewer in number than the capacitors of the booster section 30.

The capacitors of the booster section 30 and the capacitors of the smoothing section 40 in the present exemplary embodiment are all elements with the same capacitance.

In the present exemplary embodiment, as illustrated in Table 1, the capacitors of the booster section 30 are labeled, in sequence, as a first capacitor CB₁, a second capacitor CB₂ and a third capacitor CB₃. The capacitors of the smoothing section 40 are labeled, in sequence, as a first capacitor CS₁ and a second capacitor CS₂. In the tables below, only the reference symbols of these elements are listed; element names such as “first capacitor” and the like are not listed.

TABLE 1

| | Section | | | | |
|---|---|---|---|---|---|
| | Booster section | | | Smoothing section | |
| Capacitor position | 1st | 2nd | 3rd | 1st | 2nd |
| Capacitor label | CB₁ | CB₂ | CB₃ | CS₁ | CS₂ |

In the descriptions below, where the capacitors of the booster section 30 are not to be distinguished, they are referred to as “the capacitor(s) CB” without any subscript. Similarly, where the capacitors of the smoothing section 40 are not to be distinguished, they are referred to as “the capacitor(s) CS” without any subscript.

In the charge pump circuit 10 according to the present exemplary embodiment, the smoothing section 40 includes an output terminal OT. One side of the output terminal OT is connected to one side of the second capacitor CS₂ in which the other side of the second capacitor CS₂ is connected to a reference potential terminal. That is, the one side of the output terminal OT is connected to the one side of the second capacitor CS₂ that is the final (highest numbered) capacitor CS in sequence of the smoothing section 40.

One sides and the other sides of the capacitors CB of the booster section 30 according to the present disclosure are connected to respective selectors SS. Each selector SS according to the present exemplary embodiment includes, as an example, four terminals: a terminal com, a terminal φ₁, a terminal φ₂ and a terminal φ₃. In the selector SS according to the present disclosure, terminal com can be connected with any one of terminal φ₁, terminal φ₂ and terminal φ₃ depending on the clock signals, which are provided from the above-mentioned clock provision circuit CT via a bus (not illustrated in the drawings).

As illustrated in FIG. 1, when a time T is indicated by the clock provision circuit CT, each selector SS according to the present disclosure connects terminal com with a terminal among terminal φ₁, terminal φ₂ and terminal φ₃ that has a matching reference subscript. For example, FIG. 1 illustrates a condition in which all of the selectors SS connect terminal com with terminal φ₁.

In the present disclosure, it is sufficient that each selector SS is capable of altering its connection in accordance with the clock signals provided from the clock provision circuit CT, and thus, specific structures are not particularly limited. For example, the selector SS may have a structure in which terminal com is electronically connected with any one of terminal φ₁, terminal φ₂ and terminal φ₃ by three transistors that are controlled in accordance with the clock signals.

In the present exemplary embodiment, the selectors SS that are connected to respective one sides of the capacitors CB of the booster section 30 are connected to respectively different lines at the same time T. Similarly, the selectors SS that are connected to the respective other sides of the capacitors CB are connected to respectively different lines at the same time. Next, operation of the charge pump circuit 10 by the capacitors CB of the booster section 30 according to the present exemplary embodiment is described.

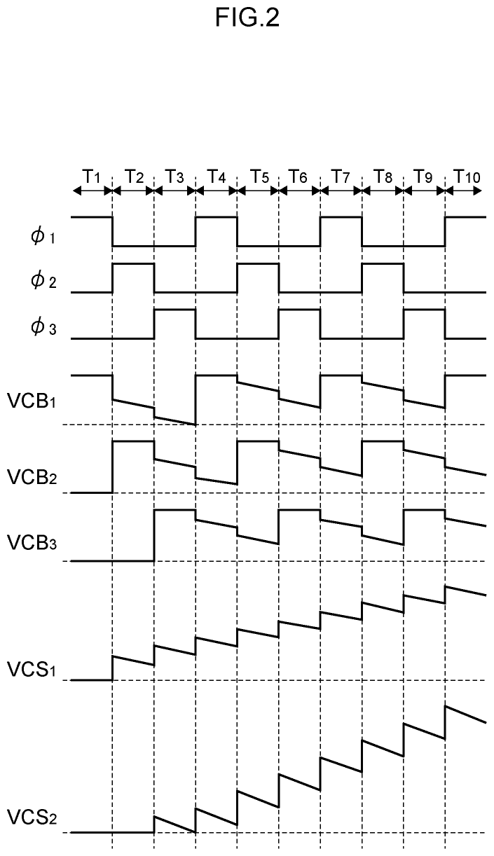

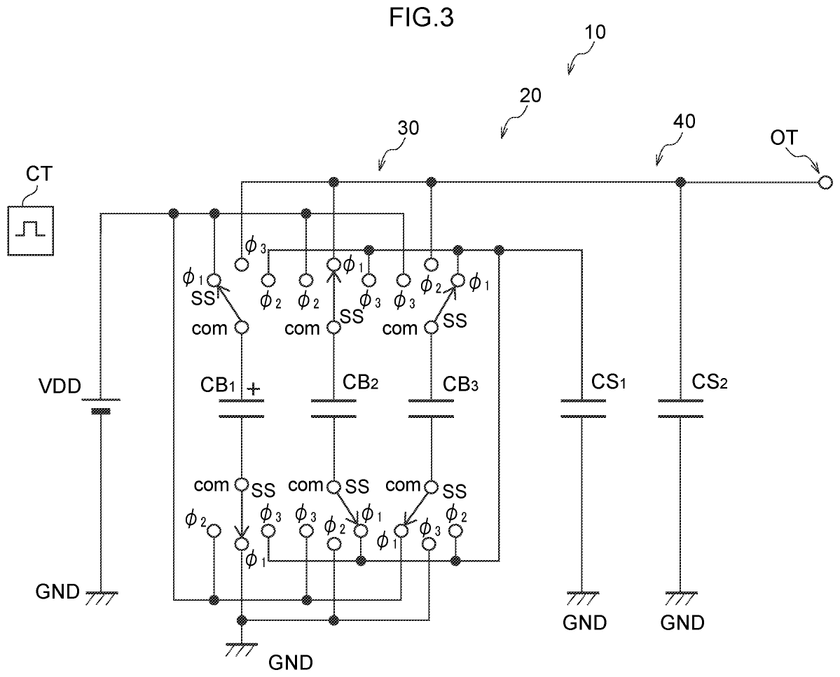

FIG. 2 is a timing chart for the charge pump circuit 10 according to the present exemplary embodiment, illustrating connections of the selectors SS and charges on the capacitors at times T. FIG. 3 to FIG. 5 are diagrams illustrating connection states of the charge pump circuit 10 at times T. In FIG. 2, an ON state of terminals φ₁ to φ₃ (in FIG. 2, a state in which a waveform has risen) represents a state in which the terminal com of the selector SS in FIG. 1 is electronically connected, and an OFF state (in FIG. 2, a state in which the waveform has fallen) represents a state in which the terminal com of the selector SS in FIG. 1 is electronically disconnected. In FIG. 2, VCB₁, VCB₂ and VCB₃ represent charges on the first capacitor CB₁, second capacitor CB₂ and third capacitor CB₃ of the booster section 30. VCS₁ and VCS₂ in FIG. 2 represent potentials of the first capacitor CS₁ and second capacitor CS₂ of the smoothing section 40. In FIG. 3 to FIG. 5, the symbols “+”, “++” and “+++” attached to the capacitors CB of the booster section 30 and the capacitors CS of the smoothing section 40 respectively represent relative heights of the capacitor potentials. That is, “+++” represents a highest potential of the capacitors, “++” represents a next highest potential, and “+” represents a potential the same as the DC power supply VDD. The absence of these symbols (for example, the second capacitor CB₂ in FIG. 3 and so forth) indicates that a capacitor is not charged.

As illustrated in FIG. 2, a selector SS according to the present exemplary embodiment is in the state in which terminal com is connected with terminal φ₁ when time T₁, T₄, T₇ or T₁₀ is indicated by the clock provision circuit CT. The selector SS is in the state in which terminal com is connected with terminal φ₂ when time T₂, T₅ or T₈ is indicated, and the selector SS is in the state in which terminal com is connected with terminal φ₃ when time T₃, T₆ or T₉ is indicated. In other words, the selector SS according to the present exemplary embodiment attains the same connection state each time the time T advances three steps.

In the present disclosure, one cycle of a capacitor CB is a period until the same connection state is attained (in the present exemplary embodiment, the period in which the time T advances three steps). A period from an initial connection to the DC power supply VDD to the next connection to the DC power supply VDD is referred to as a “first cycle”. Accordingly, the first cycles of the capacitors CB start from different times T.

As illustrated in FIG. 3, each capacitor CB of the booster section 30 is connected in the following manner in the state in which the terminal com thereof is connected to the terminal φ₁.
1. The one side of the first capacitor CB₁ is connected to the high potential side terminal of the DC power supply VDD and the other side of the first capacitor CB₁ is connected to the reference potential GND terminal.
2. The one side of the second capacitor CB₂ is connected to the one side terminal of the second capacitor CS₂ and the other side of the second capacitor CB₂ is connected to the one side terminal of the first capacitor CS₁.
3. The one side of the third capacitor CB₃ is connected to the one side terminal of the first capacitor CS₁ and the other side of the third capacitor CB₃ is connected to the high potential side terminal of the DC power supply VDD.

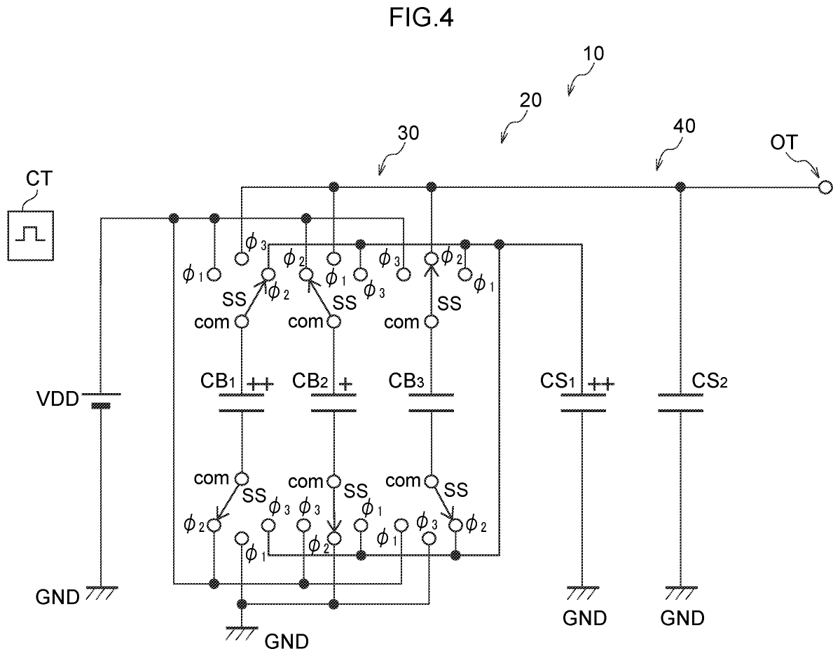

Next, as illustrated in FIG. 4, each capacitor CB of the booster section 30 is connected in the following manner in the state in which the terminal com thereof is connected to the terminal φ₂.
1. The one side of the first capacitor CB₁ is connected to the one side terminal of the first capacitor CS₁ and the other side of the first capacitor CB₁ is connected to the high potential side terminal of the DC power supply VDD.
2. The one side of the second capacitor CB₂ is connected to the high potential side terminal of the DC power supply VDD and the other side of the second capacitor CB₂ is connected to the reference potential GND terminal.
3. The one side of the third capacitor CB₃ is connected to the one side terminal of the second capacitor CS₂ and the other side of the third capacitor CB₃ is connected to the one side terminal of the first capacitor CS₁.

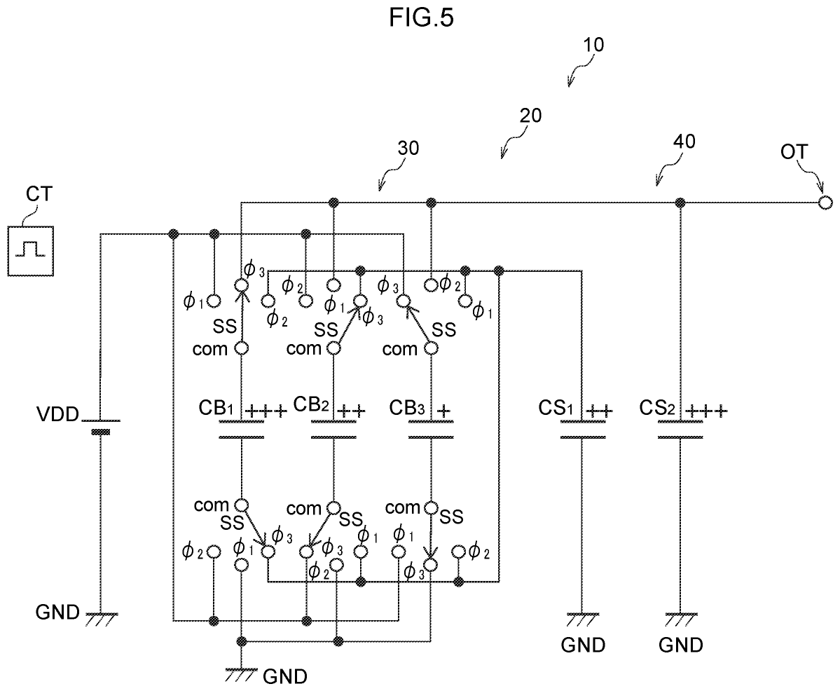

Next, as illustrated in FIG. 5, each capacitor CB of the booster section 30 is connected in the following manner in the state in which the terminal com thereof is connected to the terminal φ₃.
1. The one side of the first capacitor CB₁ is connected to the one side terminal of the second capacitor CS₂ and the other side of the first capacitor CB₁ is connected to the one side terminal of the first capacitor CS₁.
2. The one side of the second capacitor CB₂ is connected to the one side terminal of the first capacitor CS₁ and the other side of the second capacitor CB₂ is connected to the high potential side terminal of the DC power supply VDD.
3. The one side of the third capacitor CB₃ is connected to the high potential side terminal of the DC power supply VDD and the other side of the third capacitor CB₃ is connected to the reference potential GND terminal.

An arbitrary natural number i may be used to represent the times Tᵢ indicated by the clock provision circuit CT and the terminals φᵢ. As illustrated in FIG. 2 to FIG. 5, the “i” of a time T₁ indicated by the clock provision circuit CT and the “i” of a terminal φᵢ connected to terminal com have matching values up to time T₃ in the present exemplary embodiment.

As mentioned above, the same connection state is attained each time the time T advances three steps, and the connection states illustrated in FIG. 3 to FIG. 5 are repeated. Objects of connection of the capacitors CB of the booster section 30 at the respective times T are illustrated in Table 2. The symbol “VDD” in the table refers to the high potential side of the DC power supply VDD.

The area enclosed by heavy lines in Table 2 represents connections in one cycle after the booster circuit 20 starts up and each capacitor CB is charged. That is, the area enclosed by the heavy lines in the table represents the first cycles of the capacitors CB.

To describe this in more detail, in the charge pump circuit 10 according to the present exemplary embodiment, as illustrated in Table 2 and FIG. 2 to FIG. 5, operations in the first cycles of the capacitors CB of the booster section 30 after they respectively start up are as follows. First, the one side of the capacitor CB is connected to the high potential side terminal of the DC power supply VDD and the other side of the capacitor CB is connected to the reference potential GND terminal, and the capacitor CB is charged up (marked “+” in FIG. 3). Then, the one side of the capacitor CB of the booster section 30 is connected to the terminal at the one side of the first capacitor CS₁, and the other side of the capacitor CB is connected to the high potential side terminal of the DC power supply VDD, and the first capacitor CS₁ is charged up to a higher potential than the capacitor CB (marked “++” in FIG. 4). Then, the one side of the capacitor CB of the booster section 30 is connected to the terminal at the one side of the second capacitor CS₂ and the other side of the capacitor CB is connected to the terminal at the one side of the capacitor CS₁, and the second capacitor CS₂ is charged up to a higher potential than the capacitor CB (marked “+++” in FIG. 5). Hence, the operations of this one cycle are repeated by the first capacitor CB₁ to third capacitor CB₃, as a result of which the potential of the second capacitor CS₂, which is to say the voltage of the output terminal OT, rises.

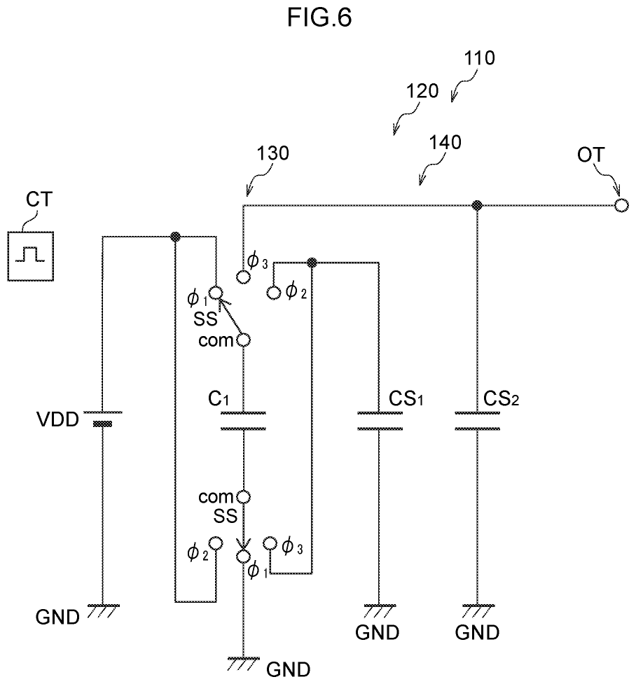

Now, a charge pump circuit 110 that is a comparative example of the charge pump circuit 10 according to the present exemplary embodiment is described, with reference where appropriate to FIG. 6 to FIG. 10. The same reference symbols are assigned to structures of the charge pump circuit 110 according to the comparative example that are similar to structures of the charge pump circuit 10 according to the present exemplary embodiment, and detailed descriptions of these structures are not given here.

As illustrated in FIG. 6, in the charge pump circuit 110 according to the comparative example, a capacitor of a booster section 130 of a booster circuit 120 is only a single first capacitor C₁. Capacitors of a smoothing section 140 are, similarly to the present exemplary embodiment, the first capacitor CS₁ and the second capacitor CS₂. Therefore, the total number of capacitors of the booster section 130 and capacitors of the smoothing section 140 is three.

A total value of capacitances of the three capacitors of the charge pump circuit 110 according to the comparative example is set to be the same as the total value of the capacitances of the five capacitors of the charge pump circuit 10 according to the present exemplary embodiment. Other structures are similar to the charge pump circuit 10 according to the present exemplary embodiment.

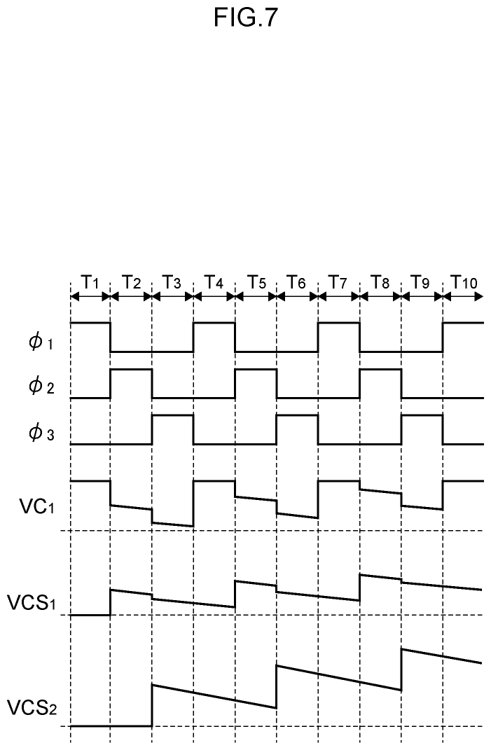

Now, operation of the charge pump circuit 110 according to the comparative example is described with reference where appropriate to FIG. 7 and FIG. 8 to FIG. 10. VC₁ in FIG. 7 represents charge on the capacitor C₁ of the booster section 130, and VCS₁ and VCS₂ in FIG. 7 represent potentials of the first capacitor CS₁ and second capacitor CS₂ of the smoothing section 140.

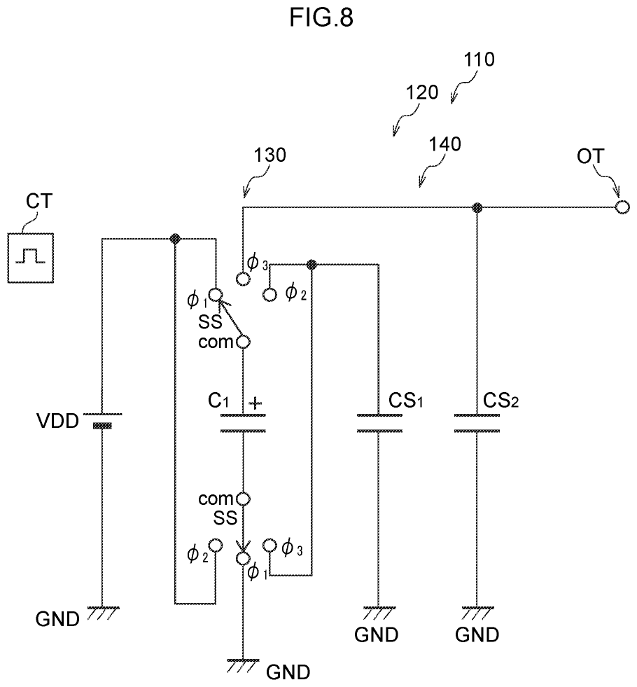

First, as illustrated in FIG. 8, in a state in which terminal com is connected to terminal φ₁, the one side of the first capacitor C₁ of the booster section 130 is connected to the high potential side terminal of the DC power supply VDD, and the other side of the first capacitor C₁ is connected to a reference potential GND terminal.

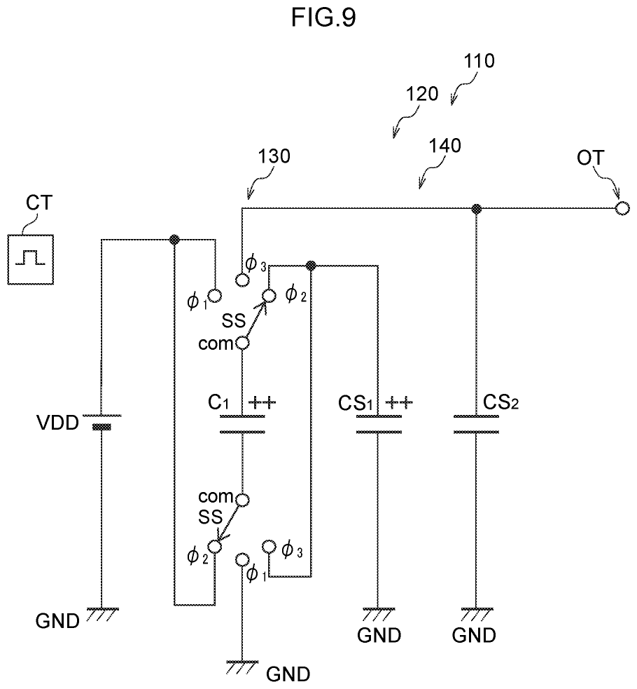

Then, as illustrated in FIG. 9, in a state in which terminal com is connected to terminal φ₂, the one side of the first capacitor C₁ of the booster section 130 is connected to the terminal at the one side of the first capacitor CS₁, and the other side of the first capacitor C₁ is connected to the high potential side terminal of the DC power supply VDD.

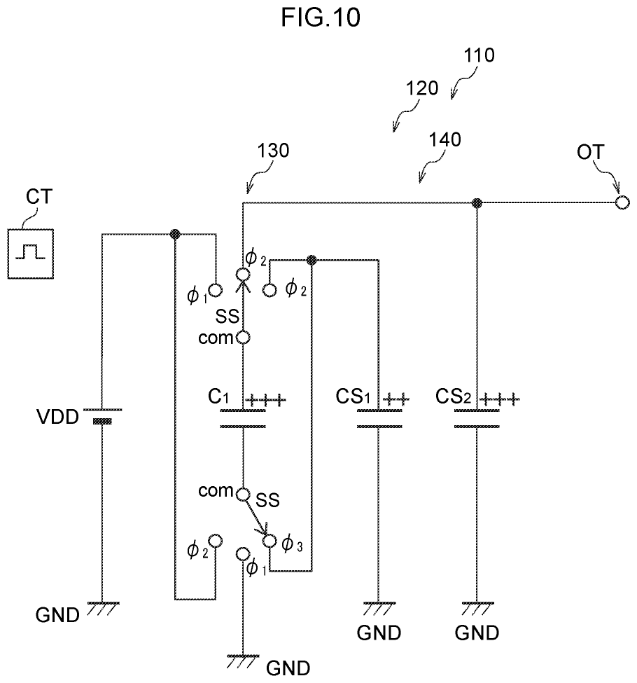

Then, as illustrated in FIG. 10, in a state in which terminal com is connected to terminal φ₃, the one side of the first capacitor C₁ of the booster section 130 is connected to the terminal at the one side of the second capacitor CS₂, and the other side of the first capacitor C₁ is connected to the terminal at the one side of the first capacitor CS₁.

Thus, as illustrated in FIG. 7, in the charge pump circuit 110 according to the comparative example, each time the time T advances three steps after time T₂, the potential VCS₂ of the second capacitor CS₂ is charged instantaneously, rather than rising in steps. That is, each time the time T advances three steps in the charge pump circuit 110 according to the comparative example, a ripple in which the potential of the second capacitor CS₂ suddenly rises is generated, that is, a ripple in the voltage of the output terminal OT is generated.

Because the charge pump circuit 110 according to the comparative example charges up each time the time T advances three steps, the voltage of the output terminal OT is likely to fall if a load connected to the output terminal OT is large (if power outputted from the output terminal OT is large). Thus, it is difficult for the charge pump circuit 110 to respond to large load variations.

In the charge pump circuit 10 according to the present exemplary embodiment, as illustrated in Table 2 and FIG. 2 to FIG. 5, the capacitors CB of the booster section 30 are connected to the second capacitor CS₂ of the smoothing section 40, respectively, each time the time T advances one step. Therefore, the potential of the second capacitor CS₂ of the smoothing section 40 is charged up each time the time T advances one step after time T₂.

As mentioned above, the total value of the capacitances of the capacitors is the same in the charge pump circuit 10 according to the present exemplary embodiment, and the charge pump circuit 110 according to the comparative example. Therefore, in the charge pump circuit 10 according to the present exemplary embodiment, a ripple in which the potential of the second capacitor CS₂ suddenly rises each time the time T advances one step. That is, a ripple on the voltage of the output terminal OT may be suppressed compared to the charge pump circuit 110 according to the comparative example.

Because the charge pump circuit 10 according to the present exemplary embodiment is charged up each time the time T advances one step, even if a load connected to the output terminal OT is large, the voltage of the output terminal OT is unlikely to fall. Therefore, it may be easier for the charge pump circuit 10 according to the present exemplary embodiment to respond to large load variations than the charge pump circuit 110 according to the comparative example.

In the descriptions above, each capacitor CB is connected with the capacitors CS of the smoothing section 40 and the DC power supply VDD even before the first cycle, for example, prior to time T₃ for the third capacitor CB₃. However, operations of the selectors SS according to the present disclosure are not limited thus. For example, a structure may be formed in which the terminal φ₁, terminal φ₂ and terminal φ₃ are not connected to the reference potential GND or the DC power supply VDD, when a time T prior to the time T of the first cycle of the respective capacitor CB is indicated.

### Second Exemplary Embodiment

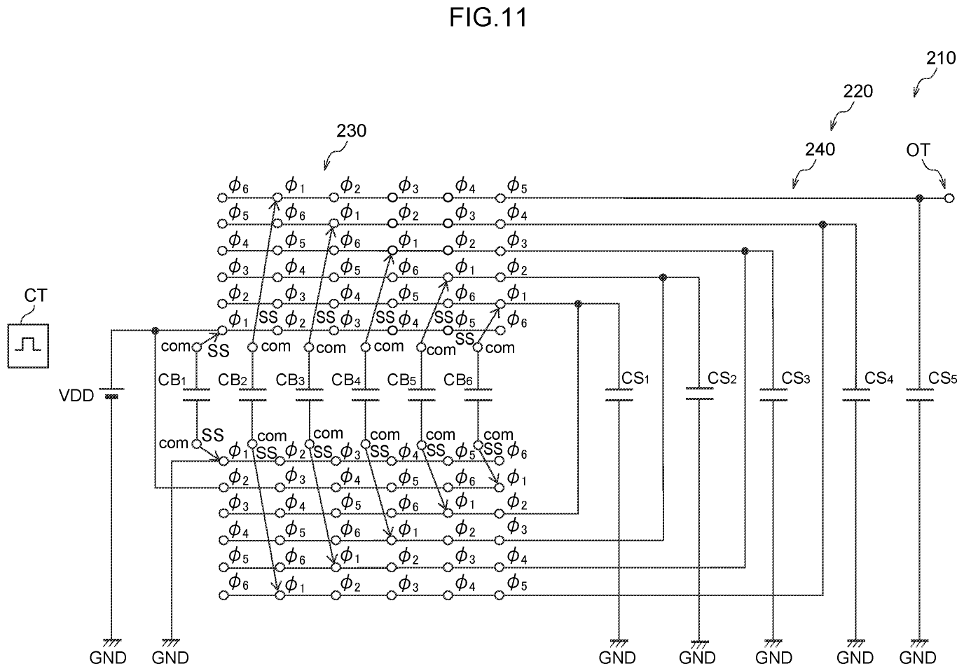

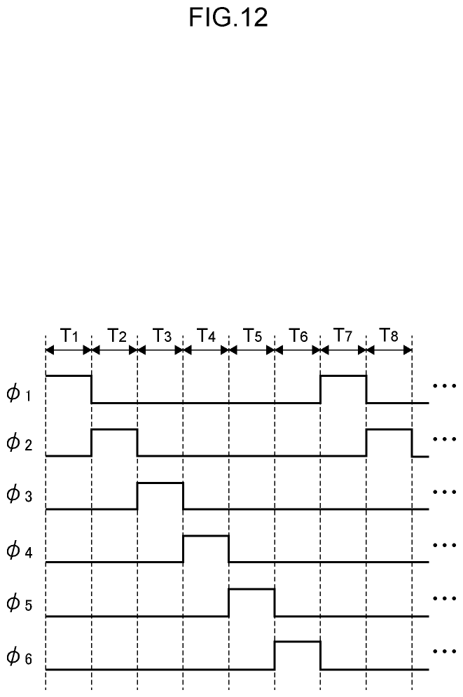

Now, a charge pump circuit 210 according to the second exemplary embodiment of the present disclosure is described with reference where appropriate to FIG. 11 and FIG. 12. In the charge pump circuit 210 according to the present exemplary embodiment, the same reference symbols as in the first exemplary embodiment are applied to structures that are the same as in the first exemplary embodiment, and detailed descriptions thereof are not given here.

As illustrated in FIG. 11, the charge pump circuit 210 according to the present exemplary embodiment differs from the charge pump circuit 10 according to the first exemplary embodiment in the number of capacitors in a booster section 230 of a booster circuit 220 and the number of capacitors in a smoothing section 240. More specifically, as illustrated in FIG. 11, the booster circuit 220 according to the present exemplary embodiment includes the booster section 230 including six capacitors and the smoothing section 240 including five capacitors. That is, the capacitors of the smoothing section 240 are one fewer in number than the capacitors of the booster section 230 in the present exemplary embodiment too.

In the present exemplary embodiment, as illustrated in Table 3, the capacitors of the booster section 230 are labeled, in sequence, as a first capacitor CB₁, a second capacitor CB₂, a third capacitor CB₃, a fourth capacitor CB₄, a fifth capacitor CB₅ and a sixth capacitor CB₆. The capacitors of the smoothing section 240 are labeled, in sequence, as a first capacitor CS₁, a second capacitor CS₂, a third capacitor CS₃, a fourth capacitor CS₄ and a fifth capacitor CS₅.

TABLE 3

| | Section | | | | | | | | | | |
|---|---|---|---|---|---|---|---|---|---|---|---|
| | Booster section | | | | | | Smoothing section | | | | |
| | Capacitor position | | | | | | | | | | |
| | 1st | 2nd | 3rd | 4th | 5th | 6th | 1st | 2nd | 3rd | 4th | 5th |
| Capacitor label | CB₁ | CB₂ | CB₃ | CB₄ | CB₅ | CB₆ | CS₁ | CS₂ | CS₃ | CS₄ | CS₅ |

In the charge pump circuit 210 according to the present exemplary embodiment, the smoothing section 240 includes the output terminal OT. The one side of the output terminal OT is connected to one side of the fifth capacitor CS₅ in which the other side of the fifth capacitor CS₅ is connected to the reference potential terminal. That is, the one side of the output terminal OT is connected to the one side of the fifth capacitor CS₅ that is the final (highest numbered) capacitor CS in sequence of the smoothing section 240.

The one sides and the other sides of the capacitors CB of the booster section 230 according to the present disclosure are connected to respective selectors SS. Each selector SS according to the present exemplary embodiment includes, as an example, seven terminals: a terminal com, a terminal φ₁, a terminal φ₂, a terminal φ₃, a terminal φ₄, a terminal φ₅ and a terminal φ₆. In the selector SS according to the present disclosure, the connection can be changed and terminal com may be connected with any one of terminal φ₁, terminal φ₂, terminal φ₃, terminal φ₄, terminal φ₅ and terminal φ₆, depending on the clock signals provided from the above-mentioned clock provision circuit CT.

Other structures are similar to the charge pump circuit 10 according to the first exemplary embodiment.

In the present exemplary embodiment too, the selectors SS that are connected to the respective one sides of the first capacitor CB₁ to sixth capacitor CB₆ of the booster section 230 are connected to respectively different lines at the same time T. Similarly, the selectors SS that are connected to the respective other sides of the first capacitor CB₁ to sixth capacitor CB₆ are connected to respectively different lines at the same time T. Next, operation of the charge pump circuit 210 by the first capacitor CB₁ to sixth capacitor CB₆ of the booster section 230 according to the present exemplary embodiment is described.

FIG. 12 is a timing chart for the charge pump circuit 210 according to the present exemplary embodiment, illustrating connections of the selectors SS at times T. In FIG. 12, the ON state of terminals φ₁ to φ₆ represents a state in which to the terminal com of the selector SS in FIG. 11 is electronically connected, and the OFF state represents a state in which terminal com of the selector SS in FIG. 11 is electronically disconnected.

As illustrated in FIG. 12, a selector SS according to the present exemplary embodiment is in the state in which terminal com is connected with terminal φ₁ when time T₁ or T₇ is indicated by the clock provision circuit CT. The selector SS is in the state in which terminal com is connected with terminal φ₂ when time T₂ is indicated, the selector SS is in the state in which terminal com is connected with terminal φ₃ when time T₃ is indicated, the selector SS is in the state in which terminal com is connected with terminal φ₄ when time T₄ is indicated, the selector SS is in the state in which terminal com is connected with terminal φ₅ when time T₅ is indicated, and the selector SS is in the state in which terminal com is connected with terminal φ₆ when time T₆ is indicated. In other words, the selector SS according to the present exemplary embodiment attains the same connection state each time the time T advances six steps.

Each capacitor CB of the booster section 230 is connected in the following manner in the state in which the terminal com thereof is connected to the terminal φ₁.
1. The one side of the first capacitor CB₁ is connected to the high potential side terminal of the DC power supply VDD, and the other side of the first capacitor CB₁ is connected to the reference potential GND terminal.
2. The one side of the second capacitor CB₂ is connected to the one side terminal of the fifth capacitor CS₅, and the other side of the second capacitor CB₂ is connected to the one side terminal of the fourth capacitor CS₄.
3. The one side of the third capacitor CB₃ is connected to the one side terminal of the fourth capacitor CS₄, and the other side of the third capacitor CB₃ is connected to the one side terminal of the third capacitor CS₃.
4. The one side of the fourth capacitor CB₄ is connected to the one side terminal of the third capacitor CS₃, and the other side of the fourth capacitor CB₄ is connected to the one side terminal of the second capacitor CS₂.
5. The one side of the fifth capacitor CB₅ is connected to the one side terminal of the second capacitor CS₂, and the other side of the fifth capacitor CB₅ is connected to the one side terminal of the first capacitor CS₁.
6. The one side of the sixth capacitor CB₆ is connected to the one side terminal of the first capacitor CS₁, and the other side of the sixth capacitor CB₆ is connected to the high potential side terminal of the DC power supply VDD.

Next, each capacitor CB of the booster section 230 is connected in the following manner in the state in which the terminal com thereof is connected to the terminal φ₂.
1. The one side of the first capacitor CB₁ is connected to the one side terminal of the first capacitor CS₁, and the other side of the first capacitor CB₁ is connected to the high potential side terminal of the DC power supply VDD.
2. The one side of the second capacitor CB₂ is connected to the high potential side terminal of the DC power supply VDD, and the other side of the second capacitor CB₂ is connected to the reference potential GND terminal.
3. The one side of the third capacitor CB₃ is connected to the one side terminal of the fifth capacitor CS₅, and the other side of the third capacitor CB₃ is connected to the one side terminal of the fourth capacitor CS₄.
4. The one side of the fourth capacitor CB₄ is connected to the one side terminal of the fourth capacitor CS₄, and the other side of the fourth capacitor CB₄ is connected to the one side terminal of the third capacitor CS₃.
5. The one side of the fifth capacitor CB₅ is connected to the one side terminal of the third capacitor CS₃, and the other side of the fifth capacitor CB₅ is connected to the one side terminal of the second capacitor CS₂.
6. The one side of the sixth capacitor CB₆ is connected to the one side terminal of the second capacitor CS₂, and the other side of the sixth capacitor CB₆ is connected to the one side terminal of the first capacitor CS₁.

Next, each capacitor CB of the booster section 230 is connected in the following manner in the state in which the terminal com thereof is connected to the terminal φ₃.
1. The one side of the first capacitor CB₁ is connected to the one side terminal of the second capacitor CS₂, and the other side of the first capacitor CB₁ is connected to the one side terminal of the first capacitor CS₁.
2. The one side of the second capacitor CB₂ is connected to the one side terminal of the first capacitor CS₁, and the other side of the second capacitor CB₂ is connected to the high potential side terminal of the DC power supply VDD.
3. The one side of the third capacitor CB₃ is connected to the high potential side terminal of the DC power supply VDD, and the other side of the third capacitor CB₃ is connected to the reference potential GND terminal.
4. The one side of the fourth capacitor CB₄ is connected to the one side terminal of the fifth capacitor CS₅, and the other side of the fourth capacitor CB₄ is connected to the one side terminal of the fourth capacitor CS₄.
5. The one side of the fifth capacitor CB₅ is connected to the one side terminal of the fourth capacitor CS₄, and the other side of the fifth capacitor CB₅ is connected to the one side terminal of the third capacitor CS₃.
6. The one side of the sixth capacitor CB₆ is connected to the one side terminal of the third capacitor CS₃, and the other side of the sixth capacitor CB₆ is connected to the one side terminal of the second capacitor CS₂.

Next, each capacitor CB of the booster section 230 is connected in the following manner in the state in which the terminal com thereof is connected to the terminal φ₄.
1. The one side of the first capacitor CB₁ is connected to the one side terminal of the third capacitor CS₃, and the other side of the first capacitor CB₁ is connected to the one side terminal of the second capacitor CS₂.
2. The one side of the second capacitor CB₂ is connected to the one side terminal of the second capacitor CS₂, and the other side of the second capacitor CB₂ is connected to the one side terminal of the first capacitor CS₁.
3. The one side of the third capacitor CB₃ is connected to the one side terminal of the first capacitor CS₁, and the other side of the third capacitor CB₃ is connected to the high potential side terminal of the DC power supply VDD.
4. The one side of the fourth capacitor CB₄ is connected to the high potential side terminal of the DC power supply VDD, and the other side of the fourth capacitor CB₄ is connected to the reference potential GND terminal.
5. The one side of the fifth capacitor CB₅ is connected to the one side terminal of the fifth capacitor CS₅, and the other side of the fifth capacitor CB₅ is connected to the one side terminal of the fourth capacitor CS₄.
6. The one side of the sixth capacitor CB₆ is connected to the one side terminal of the fourth capacitor CS₄, and the other side of the sixth capacitor CB₆ is connected to the one side terminal of the third capacitor CS₃.

Next, each capacitor CB of the booster section 230 is connected in the following manner in the state in which the terminal com thereof is connected to the terminal φ₅.
1. The one side of the first capacitor CB₁ is connected to the one side terminal of the fourth capacitor CS₄, and the other side of the first capacitor CB₁ is connected to the one side terminal of the third capacitor CS₃.
2. The one side of the second capacitor CB₂ is connected to the one side terminal of the third capacitor CS₃, and the other side of the second capacitor CB₂ is connected to the one side terminal of the second capacitor CS₂.
3. The one side of the third capacitor CB₃ is connected to the one side terminal of the second capacitor CS₂, and the other side of the third capacitor CB₃ is connected to the one side terminal of the first capacitor CS₁.
4. The one side of the fourth capacitor CB₄ is connected to the one side terminal of the first capacitor CS₁, and the other side of the fourth capacitor CB₄ is connected to the high potential side terminal of the DC power supply VDD.
5. The one side of the fifth capacitor CB₅ is connected to the high potential side terminal of the DC power supply VDD, and the other side of the fifth capacitor CB₅ is connected to the reference potential GND terminal.
6. The one side of the sixth capacitor CB₆ is connected to the one side terminal of the fifth capacitor CS₅, and the other side of the sixth capacitor CB₆ is connected to the one side terminal of the fourth capacitor CS₄.

Next, each capacitor CB of the booster section 230 is connected in the following manner in the state in which the terminal com thereof is connected to the terminal φ₆.
1. The one side of the first capacitor CB₁ is connected to the one side terminal of the fifth capacitor CS₅, and the other side of the first capacitor CB₁ is connected to the one side terminal of the fourth capacitor CS₄.
2. The one side of the second capacitor CB₂ is connected to the one side terminal of the fourth capacitor CS₄, and the other side of the second capacitor CB₂ is connected to the one side terminal of the third capacitor CS₃.
3. The one side of the third capacitor CB₃ is connected to the one side terminal of the third capacitor CS₃, and the other side of the third capacitor CB₃ is connected to the one side terminal of the second capacitor CS₂.
4. The one side of the fourth capacitor CB₄ is connected to the one side terminal of the second capacitor CS₂, and the other side of the fourth capacitor CB₄ is connected to the one side terminal of the first capacitor CS₁.
5. The one side of the fifth capacitor CB₅ is connected to the one side terminal of the first capacitor CS₁, and the other side of the fifth capacitor CB₅ is connected to the high potential side terminal of the DC power supply VDD
6. The one side of the sixth capacitor CB₆ is connected to the high potential side terminal of the DC power supply VDD, and the other side of the sixth capacitor CB₆ is connected to the reference potential GND terminal.

The “i” of a time T₁ indicated by the clock provision circuit CT and the “i” of a terminal φᵢ connected to terminal com have matching values in the first cycle according to the present exemplary embodiment.

As mentioned above, the same connection state is repeated each time the time T advances six steps. Objects of connection of the capacitors CB of the booster section 230 at the respective times T are illustrated in Table 4.

The area enclosed by the heavy lines in Table 4 represents connections in the first cycles of the capacitors CB after the booster circuit 220 starts up. In other words, the area enclosed by the heavy lines in the table represents first cycles in which the capacitors CB are initially charged up.

In the charge pump circuit 210 according to the present exemplary embodiment, similarly to the first exemplary embodiment, a ripple in which the potential of the fifth capacitor CS₅ suddenly rises each time the time T advances one step, that is, a ripple on the voltage of the output terminal OT is suppressed compared to the charge pump circuit 110 according to the comparative example. In the charge pump circuit 210 according to the present exemplary embodiment, because the number of the capacitors CB of the booster section 230 is six, ripple on the voltage of the output terminal OT is further suppressed compared to when the number of capacitors CB of the booster section 230 is five or less.

### Third Exemplary Embodiment

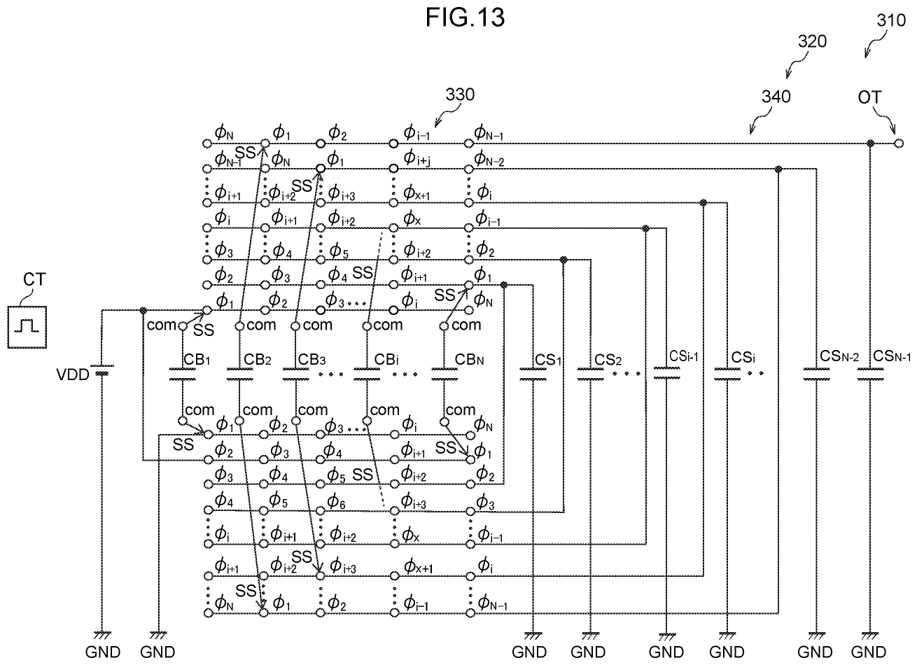

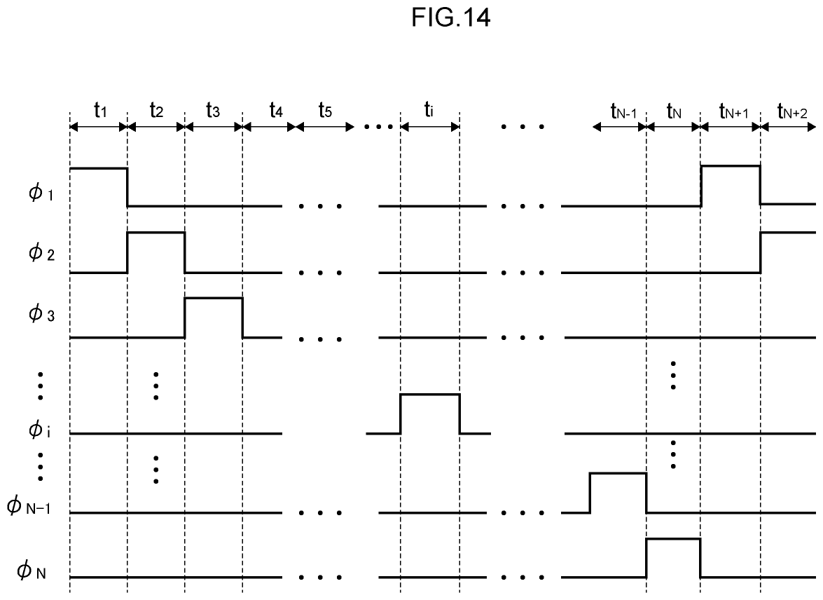

Now, a charge pump circuit 310 according to the third exemplary embodiment of the present disclosure is described with reference where appropriate to FIG. 13 and FIG. 14. In the charge pump circuit 310 according to the present exemplary embodiment, the same reference symbols as in the first exemplary embodiment or second exemplary embodiment are applied to structures that are the same as in the first exemplary embodiment or second exemplary embodiment, and detailed descriptions thereof are not given here.

The present exemplary embodiment is described using an arbitrary natural number N for the number of capacitors of a booster section 330 and the number of capacitors of a smoothing section 340. More specifically as illustrated in FIG. 13, a booster circuit 320 according to the present exemplary embodiment includes the booster section 330 including the arbitrary natural number N of capacitors and the smoothing section 340 including N−1 capacitors. That is, the capacitors of the smoothing section 340 are one fewer in number than the capacitors of the booster section 330 in the present exemplary embodiment too.

In the present exemplary embodiment, as illustrated in Table 5, the capacitors of the booster section 330 are described using the arbitrary natural number N and natural numbers i from 1 to N. In the descriptions below, the capacitors of the booster section 330 are labeled, in sequence, as a first capacitor CB₁, a second capacitor CB₂, . . . , an i^{th} capacitor CBᵢ, . . . and an N^{th} capacitor CB_{N}. The capacitors of the smoothing section 340 are similarly labeled, in sequence, as a first capacitor CS₁, a second capacitor CS₂, . . . , an i^{th} capacitor CSᵢ, . . . and an N^{th} capacitor CS_{N-1}.

TABLE 5

| | Section | | | | | | | | | | | |
|---|---|---|---|---|---|---|---|---|---|---|---|---|
| | Booster section | | | | | | Smoothing section | | | | | |
| | Capacitor position | | | | | | | | | | | |
| | 1st | 2nd | . . . | ith | . . . | Nth | 1st | 2nd | . . . | ith | . . . | N − 1th |
| Capacitor label | CB₁ | CB₂ | . . . | CBᵢ | . . . | CB_{N} | CS₁ | CS₂ | . . . | CSᵢ | . . . | CS_{N-1} |

In the charge pump circuit 310 according to the present exemplary embodiment, the smoothing section 340 includes the output terminal OT. The one side of the output terminal OT is connected to one side of the N−1th capacitor CS_{N-1} in which the other side of the N−1^{th} capacitor CS_{N-1} is connected to the reference potential terminal. That is, the one side of the output terminal OT is connected to the one side of the N−1th capacitor CS_{N-1} that is the final (highest numbered) capacitor CS in sequence of the smoothing section 340.

One sides and the other sides of the capacitors CB of the booster section 330 according to the present disclosure are connected to respective selectors SS. Each selector SS according to the present exemplary embodiment includes, as an example, N+1 terminals: a terminal com, a terminal φ₁, a terminal φ₂, a terminal φ₃, . . . , a terminal φᵢ, a terminal φᵢ₊₁, . . . , a terminal O_{N-1} and a terminal φ_{N}. In the selector SS according to the present disclosure, the connection can be changed and terminal com connected with any one of terminal φ₁, terminal φ₂, terminal φ₃, . . . , terminal φᵢ, terminal φᵢ₊₁, . . . , terminal φ_{N-1} and terminal φ_{N} depending on the clock signals provided from the above-mentioned clock provision circuit CT. In FIG. 13, terminals with specific connections at time T that are at positions that cannot be illustrated in the drawing are depicted as terminal ϕₓ and terminal φₓ₊₁ to facilitate understanding.

Other structures are similar to the charge pump circuit 10 or charge pump circuit 210 according to the first exemplary embodiment or second exemplary embodiment.

In the present exemplary embodiment too, the selectors SS that are connected to the respective one sides of the first capacitor CB₁ to N^{th} capacitor CB_{N} of the booster section 330 are connected to respectively different lines at the same time. Similarly, the selectors SS that are connected to the respective other sides of the first capacitor CB₁ to N^{th} capacitor CB_{N} are connected to respectively different lines at the same time T. Next, operation of the charge pump circuit 310 by the first capacitor CB₁ to N^{th} capacitor CB_{N} at times T according to the selectors SS of the booster section 330 according to the present exemplary embodiment is described.

FIG. 14 is a timing chart for the charge pump circuit 310 according to the present exemplary embodiment, illustrating connections of the selectors SS at times T. The ON state of terminals φ₁ to φ_{N} in FIG. 14 represents a state in which terminal com of the selector SS in FIG. 13 is electronically connected, and the OFF state represents a state in which terminal com of the selector SS in FIG. 13 is electronically disconnected.

As illustrated in FIG. 14, a selector SS according to the present exemplary embodiment is in the state in which terminal com is connected with terminal φ₁ when time T₁ or T_{N+1} is indicated by the clock provision circuit CT. The selector SS is in the state in which terminal com is connected with terminal φ₂ when time T₂ is indicated, the selector SS is in the state in which terminal com is connected with terminal φ₃ when time T₃ is indicated, and similarly otherwise, the selector SS is in a state in which terminal com is connected with terminal φᵢ when time Tᵢ is indicated. Using the arbitrary natural number N for this explanation, the selector SS is in a state in which terminal com is connected with terminal φ_{N} when time T_{N} is indicated. That is, the selector SS according to the present exemplary embodiment attains the same connection state each time the time T advances N steps.

Each capacitor CB of the booster section 330 is connected in the following manner in the state in which the terminal com thereof is connected to the terminal φ₁. Note that, between 2. and i. and between i+1. and N−1., the preceding and succeeding connections are similar, and are not described here.
1. The one side of the first capacitor CB₁ is connected to the high potential side terminal of the DC power supply VDD, and the other side of the first capacitor CB₁ is connected to the reference potential GND terminal.
2. The one side of the second capacitor CB₂ is connected to the one side terminal of the N−1^{th} capacitor CS_{N-1}, and the other side of the second capacitor CB₂ is connected to the one side terminal of the N−2^{th} capacitor CS_{N<2}.
i. The one side of the i^{th} capacitor CBᵢ is connected to the one side terminal of the N−(i−1)^{th} capacitor CS_{N-(i-1)}, and the other side of the i^{th} capacitor CBᵢ is connected to the one side terminal of the N−(i−2)^{th} capacitor CS_{N-(i-2)}.

N−1. The one side of the N−1^{th} capacitor CB_{N-1} is connected to the one side terminal of the second capacitor CS₂, and the other side of the N−1^{th} capacitor CB_{N-1} is connected to the one side terminal of the first capacitor CS₁.

N. The one side of the N^{th} capacitor CB_{N} is connected to the one side terminal of the first capacitor CS₁, and the other side of the N^{th} capacitor CB_{N} is connected to the high potential side terminal of the DC power supply VDD.

Next, each capacitor CB of the booster section 330 is connected in the following manner in the state in which the terminal com thereof is connected to the terminal φ₂. Nite that, Between 2. and i. and between i+1. and N−1., the preceding and succeeding connections are similar, and are not described here.
1. The one side of the first capacitor CB₁ is connected to the one side terminal of the first capacitor CS₁, and the other side of the first capacitor CB₁ is connected to the high potential side terminal of the DC power supply VDD.
2. The one side of the second capacitor CB₂ is connected to the high potential side terminal of the DC power supply VDD, and the other side of the second capacitor CB₂ is connected to the reference potential GND terminal.
i. The one side of the i^{th} capacitor CB; is connected to the one side terminal of the N−i^{th} capacitor CS_{N-i}, and the other side of the i^{th} capacitor CB; is connected to the one side terminal of the N−(i−1)th capacitor CS_{N-(i-1)}.
N−1. The one side of the N−1^{th} capacitor CB_{N-1} is connected to the one side terminal of the third capacitor CS₃, and the other side of the N−1^{th} capacitor CB_{N-1} is connected to the one side terminal of the second capacitor CS₂.
N. The one side of the N^{th} capacitor CB_{N} is connected to the one side terminal of the second capacitor CS₂, and the other side of the N^{th} capacitor CB_{N} is connected to the one side terminal of the first capacitor CS₁.

Subsequent connection states are similarly connected until the state in which terminal com is connected to terminal φ_{N}. Therefore, the capacitors CB of the booster section 330 according to the present exemplary embodiment each attain each of the following connection states A. to C., in which i represents natural numbers i from 1 to N and j represents natural numbers from 2 to N−1.
A. The one side is connected to the high potential side terminal of the DC power supply VDD, and the other side is connected to the reference potential GND terminal.
B. The one side is connected to the one side terminal of the first capacitor CS₁, and the other side is connected to the high potential side terminal of the DC power supply VDD.
C. The one side is connected to the one side terminal of the i+j^{th} capacitor CSᵢ₊ⱼ (a capacitor CS other than the first capacitor CS₁), and the other side is connected to the one side terminal of the i+j−1^{th} capacitor CSᵢ₊ⱼ₋₁ (the capacitor one prior to the i+j^{th} capacitor CSᵢ₊ⱼ in the sequence).

The “i” of a time Tᵢ indicated by the clock provision circuit CT and the “i” of a terminal φᵢ connected to terminal com have matching values in the first cycle according to the present exemplary embodiment.

That is, connection states of the i^{th} capacitor CBᵢ, which is the i^{th} capacitor of the booster section 330 according to the present exemplary embodiment, in the first cycle can be generalized as follows with i representing natural numbers from 1 to N and j representing natural numbers from 2 to N−1.
A. When time Tᵢ is indicated by the clock signals, the one side is connected to the high potential side terminal of the DC power supply VDD, and the other side is connected to the reference potential GND terminal.
B. When time Tᵢ₊₁ is indicated by the clock signals, the one side is connected to the one side terminal of the first capacitor of the smoothing section 340, and the other side is connected to the high potential side terminal of the DC power supply VDD.
C. When time Tᵢ₊ⱼ is indicated by the clock signals, the one side is connected to the one side terminal of the j^{th} capacitor of the smoothing section 340, and the other side is connected to the one side terminal of the j−1^{th} capacitor of the smoothing section 340.

As mentioned above, the same connection state is repeated each time the time T advances N steps. Objects of connection at respective times T of, among the capacitors CB of the booster section 330, the first capacitor CB₁, the second capacitor CB₂, each i^{th} capacitor CBᵢ, each i+1^{th} capacitor CBᵢ₊₁, the N−1^{th} capacitor CB_{N-1} and the N^{th} capacitor CB_{N} are illustrated in Table 6 to Table 8. Each diagonal three-dot line in the tables indicates connections the same as connections in the table cell to the upper left thereof.

The areas enclosed by the heavy lines in the tables represent connections in the first cycles of the capacitors CB after the booster circuit 320 starts up. In other words, the areas enclosed by the heavy lines in the tables represent first cycles in which the capacitors CB are initially charged up.

That is, connection states of each i^{th} capacitor CBᵢ among the N capacitors CB of the booster section 330 according to the present exemplary embodiment in a second and subsequent cycles can be generalized as follows, with M representing a natural number that is at least 2.
A. When time T_{M×N+i} is indicated by the clock signals, the connection state is the same as at time Ti.
B. When time T_{M×N+i+1} is indicated by the clock signals, the connection state is the same as at time Tᵢ₊₁.
C. When time T_{M×N+i+j} is indicated by the clock signals, the connection state is the same as at time Tᵢ₊ⱼ.

In the charge pump circuit 310 according to the present exemplary embodiment, similarly to the first exemplary embodiment and the second exemplary embodiment, a ripple in which the potential of the N^{th} capacitor CS_{N} that is connected to the output terminal OT suddenly rises each time the time T advances one step may be suppressed, compared to the charge pump circuit 110 according to the comparative example. In the charge pump circuit 310 according to the present exemplary embodiment, since the number of the capacitors CB of the booster section 330 is N, ripple on the voltage of the output terminal OT is further suppressed compared to when the number of capacitors CB of the booster section 330 is N−1 or less.

Embodiments of the present disclosure are described above with reference to the attached drawings. It will be clear to the practitioner having ordinary skill in the field of art of the present disclosure that numerous modifications and applications are possible within the scope of the technical gist recited in the attached claims, and it should be understood that these modifications and applications are to be encompassed by the technical scope of the invention.

What is claimed is:

1. A charge pump circuit comprising:
a DC power supply;
a booster circuit including a booster section and a smoothing section, the booster section including N capacitors, where N is an arbitrary natural number that is at least 3, and the smoothing section including N−1 capacitors; and
a clock provision circuit that provides clock signals to the booster circuit,
wherein, in a case in which i is natural numbers from 1 to N, and j is natural numbers from 2 to N−1,
when a time Tᵢ is indicated by the clock signals, one side of an i^{th} capacitor among the N capacitors of the booster section is connected to a high potential side terminal of the DC power supply, and an other side of the i^{th} capacitor is connected to a reference potential terminal,
when a time Tᵢ₊₁ is indicated by the clock signals, the one side is connected to a terminal at one side of a first capacitor of the smoothing section, and the other side is connected to the high potential side terminal of the DC power supply, and
when a time Tᵢ₊ⱼ is indicated by the clock signals, the one side is connected to a terminal at one side of a j^{th} capacitor of the smoothing section, and the other side is connected to a terminal at one side of a j−1^{th} capacitor of the smoothing section.

2. The charge pump circuit according to claim 1, wherein the i^{th} capacitor among the N capacitors of the booster section attains the same connection state each time the time T indicated by the clock signals advances N steps.

3. The charge pump circuit according to claim 1, wherein N is 3.
